(19) United States
(12) Patent Application Publication
(10) Pub. No.: US 2015/0130361 A1
(43) Pub. Date: May 14, 2015

(54) LED BACKLIGHT DRIVING CIRCUIT AND METHOD FOR DRIVING THE LED BACKLIGHT DRIVING CIRCUIT

(71) Applicant: SHENZHEN CHINA STAR OPTOELECTRONICS TECHNOLOGY CO. LTD., Shenzhen (CN)

(72) Inventor: Xianming Zhang, Shenzhen (CN)

(21) Appl. No.: 14/233,768

(22) PCT Filed: Oct. 23, 2013
(86) PCT No.: PCT/CN2013/085737

§ 371 Date: Jan. 20, 2014

(30) Foreign Application Priority Data
Oct. 21, 2013 (CN) 20131049549.0

(51) Int. Cl. H05B 33/08; G09G 3/34

(52) U.S. Cl. CPC H05B 33/083; H05B 33/0815; H05B 33/0851; G09G 3/3426
USPC 315/186

(57) ABSTRACT

A light emitting diode (LED) backlight driving circuit includes a power supply, at least two connected-in-parallel LED lightbars coupled to an output end of the power supply, a power feedback assembly coupled to each of the LED lightbars, and an adjusting-power block coupled to the power feedback assembly. A reference end of the power feedback assembly receives a reference power, and the power feedback assembly receives an output power of each of the LED lightbars. The power feedback assembly obtains a difference value of the reference power compared with the output power of the LED lightbar, and the adjusting-power block adjusts the output power of a corresponding LED lightbar according to the difference value until the difference value is less than a preset threshold value.

### TECHNICAL FIELD

The present disclosure relates to the field of display device, and more particularly to a light emitting diode (LED) backlight driving circuit and a method for driving the LED backlight driving circuit.

### BACKGROUND

A thin film transistor liquid crystal display (TFT-LCD) assembly includes a liquid crystal display (LCD) panel and a backlight assembly, where the backlight assembly uses a light emitting diode (LED) lightbar formed by a plurality of connected-in-series LED lamps to provide a light source for the LCD panel. A plurality of LED lightbars are used to drive a large size TFT-LCD assembly, where each of the plurality of LED lightbars is connected to each other in parallel, and an output end of each of the LED lightbars is connected in series with other circuit. Each of the LED lightbars is not completely same as each other, which causes the LCD panel to exhibit brightness differences.

### SUMMARY

The aim of the present disclosure is to provide a light emitting diode (LED) backlight driving circuit and a method for driving the LED backlight driving circuit capable of reducing brightness difference between the LED lightbars.

The aim of the present disclosure is achieved by the following methods.

A light emitting diode (LED) backlight driving circuit comprises a power supply, at least two connected-in-parallel LED lightbars connected to an output end of the power supply, a power feedback assembly coupled to each of the LED lightbars, and an adjusting-power block coupled to the power feedback assembly. A reference end of the power feedback assembly receives a reference power, and the power feedback assembly receives an output power of each of the LED lightbars. The power feedback assembly obtains a difference value of the reference power compared with the output power of the LED lightbars, and the adjusting-power block adjusts the output power of a corresponding LED lightbar according to the difference value until the difference value is less than a preset threshold value.

Furthermore, the adjusting-power block comprises a third amplifier, a fourth amplifier, a fifth resistor, a sixth resistor, a seventh resistor, an eighth resistor, and a ninth resistor; a second input end of the third amplifier is coupled to an output end of the power feedback assembly through the fifth resistor, received a reference voltage through the sixth resistor, and is coupled to an output end of the third amplifier through the seventh resistor. The output end of the third amplifier is coupled to a first input end of the fourth amplifier through the eighth resistor, and the first input end of the fourth amplifier is coupled to an output end of the fourth amplifier through the ninth resistor. A second input end of the fourth amplifier is coupled to a ground terminal of the LED backlight driving circuit.

The adjusting-power block further comprises a converting unit, where the converting unit comprises a first controllable switch, a second controllable switch, and a storage capacitor. A first end of the storage capacitor is coupled to the ground terminal of the LED backlight driving circuit, and a second end of the storage capacitor is coupled to the sixth resistor through the first controllable switch and is coupled to the output end of the fourth amplifier through the second controllable switch. The first controllable switch and the second controllable switch alternately turn on. When the first controllable switch turns on, the reference voltage is provided by the storage capacitor.

Resistance value of the fifth resistor, resistance value of the sixth resistor, resistance value of the seventh resistor, resistance value of the eighth resistor, resistance value of the ninth resistor, the reference voltage, and the difference value output by the power feedback assembly are respectively regarded as R15, R16, R17, R18, R19, Vₛ₁₋₀, and V_{z1}. The output voltage if the fourth amplifier is Vₛ₁, where Vₛ₁=Vₛ₁₋₀R17/R16±V_{z1}×R17/R15. The converting unit switches the output voltage Vₛ₁ of the fourth amplifier to a first input end of the sixth resistor, where the output voltage Vₛ₁ of the fourth amplifier is regarded as a new reference voltage. Thus, the converting unit switches every time, the output voltage Vₛ₁ of the fourth amplifier increases or decreases a number (the number increased or decreased is V_{z1}×R17/R15). Change of the output voltage Vₛ₁ of the fourth amplifier directly affects the output power of the corresponding LED lightbar, thus, the present disclosure can gradually adjust change of the output power of the LED lightbar until the difference value is less than the preset threshold value. At this time, V_{z1}=0, namely the number increased or decreased is zero, and the output voltage Vₛ₁ of the fourth amplifier does not change.

Furthermore, the resistance value of the sixth resistor is equal to the resistance value of the seventh resistor, and the resistance value of the fifth resistor is less than the resistance value of the seventh resistor. As R15<R17, R17/R15>1. Generally, V_{z1} is small, thus, in the formula of Vₛ₁=Vₛ₁₋₀R17/R16±V_{z1}×R17/R15, V_{z1}×R17/R15 of the number increased or decreased is dependent on R17/R15. When the number increased or decreased becomes greater, the speed of reducing the different value between the output power of the LED lightbar and the reference power by the adjusting-power block becomes faster, which improves feedback efficiency.

Furthermore, the LED backlight driving circuit further comprises a reference power selecting block, where the reference power selecting block comprises a multichannel selecting comparator coupled to a cathode end of each of the LED lightbars. The multichannel selecting comparator is used to select a minimum voltage of the cathode end of the LED lightbar in all voltages of the cathode ends of the LED lightbars. Each of the LED lightbars corresponds to one comparing unit. A first input end of the comparing unit is coupled to an output end of the multichannel selecting comparator and a second input end of the comparing unit is coupled to the cathode end of the corresponding LED lightbar.

The reference power selecting block further comprises an encoder, a decoder, a switching unit, where the encoder reads an output value of each of the comparing unit. The decoder finds the LED lightbar having the minimum voltage in the cathode end of the LED lightbar and controls the switching unit to switch the output power of the LED lightbar having the minimum voltage in the cathode end of the LED lightbar to a reference end of a corresponding power feedback assembly. The output power of the corresponding LED lightbar is regarded as the reference power.

In the present disclosure, the output power of the LED lightbar having a maximum voltage is regarded as the reference power. The multichannel selecting comparator selects the minimum voltage of the cathode end of the LED lightbar. When the voltage of the cathode end of the LED lightbar is at the minimum, the voltage of the LED lightbars is at the maximum. The comparing unit compares a minimum voltage output by the multichannel selecting comparator with the voltage of the cathode end of each of the LED lightbars. As the voltage of the cathode end of only one LED lightbar is equal to the minimum voltage output by the multichannel selecting comparator, the digital signal output by the comparing unit corresponding to the one LED lightbar is different with the digital signals output by other comparing units corresponding remaining LED lightbars (namely, if the comparing unit corresponding to the one LED lightbar outputs logic 0, the other comparing units output logic 1, on the contrary, if the comparing unit corresponding to the one LED lightbar outputs logic 1, the other the comparing units output logic 0). The comparing unit transfers the digital signal to the encoder, where the digital signal is obtained according to a compared result. The decoder finds the LED lightbar having the minimum voltage in the cathode end of the LED lightbar, and controls the switching unit to switch the output power of the LED lightbar having the minimum voltage in the cathode end of the LED lightbar to the reference end of the corresponding power feedback assembly corresponding to each of the LED lightbars, where the output power of the LED lightbar having the minimum voltage in the cathode end of the LED lightbar is regarded as the reference power.

Furthermore, the power feedback assembly comprises a detecting voltage block that detects a voltage of the LED lightbar, a detecting current block that detects current of the LED lightbar, and a comparing power block coupled to the detecting voltage block and the detecting current block, where the comparing power block is coupled to the adjusting-power block. The comparing power block obtains the output power of the LED lightbar through calculating a data of the detecting voltage block and a data of the detecting current block. The power feedback assembly obtains the difference value of the reference power compared with the obtained output power of the LED lightbar, and the adjusting-power block adjusts the output power of the corresponding LED lightbar according to the difference value until the difference value is less than the preset threshold value. This is a specific structure of the power feedback assembly.

Furthermore, the detecting voltage block comprises a first amplifier, a first resistor, a second resistor, a third resistor, and a fourth resistor. A first input end of the first amplifier receives an output voltage of the power supply through the first resistor and is coupled to an output end of the first amplifier through the third resistor, and a second input end of the first amplifier receives the voltage of the cathode end of the LED lightbar through the second resistor and is coupled to a ground terminal of the LED backlight driving circuit through the fourth resistor. The output end of the first amplifier is coupled to the comparing power block. The present disclosure provides a specific circuit of the detecting voltage block, the detecting voltage block subtracts the voltage of the cathode end of the LED lightbar from a voltage of an anode end of the LED lightbars to obtain the voltage of each of the LED lightbars.

Furthermore, the detecting current block comprises a sampling resistor connected in series between the cathode end of the LED lightbar and the ground terminal of the LED backlight driving circuit. The adjusting-power block provides the adjusting voltage to the cathode end of the LED lightbar, and the power feedback assembly receives the adjusting voltage. The present disclosure obtains the current of the LED lightbar through the adjusting voltage, and adjusts the current of the LED lightbar through adjusting the adjusting-power block. If the adjusting voltage is regarded as Vₛ₁ (taking a first LED lightbar for example as follows), the resistance value of the sampling resistor is R, according to Ohm's law, a current flowing through the sampling resistor is I, where I=Vₛ₁/R. The first LED lightbar is connected in series with the sampling resistor, thus, the current of the sampling resistor is equal to the current of the LED lightbar. When R=1Ω, I=Vₛ₁. When R≠1Ω, the current I of the sampling resistor and the adjusting voltage Vₛ₁ are directly proportional, thus, the adjusting voltage Vₛ₁ reflects change of the current of the sampling resistor.

Furthermore, the comparing power block comprises a first multiplier and a second amplifier. Output ends of the detecting voltage block and the detecting current block are coupled to the first multiplier. An output end of the first multiplier is coupled to a second input end of the second amplifier. A first input end of the second amplifier receives the reference power, and an output end of the second amplifier is coupled to the adjusting-power block. The present disclosure obtains the output power of the LED lightbar through the first multiplier, and the switching unit switches the current and the voltage of the corresponding LED lightbar to the second multiplier and the reference power is calculated, and the difference value is obtained through comparing the reference power with the output power of the LED lightbar.

Furthermore, the power feedback assembly comprises a detecting voltage block that detects the voltage of the LED lightbar, a detecting current block that detects the current of the LED lightbar, and a comparing power block coupled to the detecting voltage block and the detecting current block, where the comparing power block is coupled to the adjusting-power block. The comparing power block obtains the output power of the LED lightbars through calculating a data of the detecting voltage block and a data of the detecting current block. The power feedback assembly obtains the difference value of the reference power compared with the obtained output power of the LED lightbar, and the adjusting-power block adjusts the output power of the corresponding LED lightbar according to the difference value until the difference value is less than the preset threshold value.

The LED backlight driving circuit further comprises a reference power selecting block, where the reference power selecting block comprises a multichannel selecting comparator coupled to the cathode end of each of the LED lightbars. The multichannel selecting comparator is used to select a minimum voltage of the cathode end of the LED lightbar in all voltages of the cathode ends of the LED lightbars. Each of the LED lightbars corresponds to one comparing unit. A first input end of the comparing unit is coupled to an output end of the multichannel selecting comparator and a second input end of the comparing unit is coupled to the cathode end of the corresponding LED lightbar.

The reference power selecting block further comprises an encoder, a decoder, a switching unit, where the encoder reads an output value of each of the comparing unit. The decoder finds the LED lightbar having the minimum voltage in the cathode end of the LED lightbar and controls the switching unit to switch the output power of the LED lightbar having the minimum voltage in the cathode end of the LED lightbar to a reference end of the comparing power block. The output power of the corresponding LED lightbar is regarded as the reference power.

The detecting voltage block comprises a first amplifier, a first resistor, a second resistor, a third resistor, and a fourth resistor. A first input end of the first amplifier receives an output voltage of the power supply through the first resistor and is coupled to an output end of the first amplifier through the third resistor, and a second input end of the first amplifier receives the voltage of the cathode end of the LED lightbar through the second resistor and is coupled to the ground terminal of the LED backlight driving circuit through the fourth resistor.

The cathode end of the LED light bar is connected with a dimming controllable switch in series. The detecting current block comprises a sampling resistor connected in series between the dimming controllable switch and the ground terminal of the LED backlight driving circuit. The adjusting-power block provides the adjusting voltage to an output end of the dimming controllable switch.

The comparing power block comprises a first multiplier, a second multiplier, and a second amplifier, where the first multiplier receives the adjusting voltage of the adjusting-power block and is coupled to the output end of the first amplifier, and an output end of the first multiplier is coupled to a second input end of the second amplifier. The switching unit of the reference power selecting block switches the output end of the first amplifier corresponding to the LED lightbars having the minimum voltage and the adjusting voltage to the second multiplier. The second multiplier outputs the reference power to a first input end of the second amplifier; an output end of the second amplifier is coupled to the adjusting-power block.

The adjusting-power block comprises a third amplifier, a fourth amplifier, a fifth resistor, a sixth resistor, a seventh resistor, an eighth resistor, and a ninth resistor. A second input end of the third amplifier is coupled to an output end of the comparing power block through the fifth resistor, receives a reference voltage through the sixth resistor, and is coupled to an output end of the third amplifier through the seventh resistor. The output end of the third amplifier is coupled to a first input end of the fourth amplifier through the eighth resistor. A second input end of the fourth amplifier is coupled to an output end of the fourth amplifier through the ninth resistor, and the first input end of the fourth amplifier is coupled to the ground terminal of the LED backlight driving circuit.

The adjusting-power block further comprises a converting unit, where the converting unit comprises a first controllable switch, a second controllable switch, and a storage capacitor. A first end of the storage capacitor is coupled to the ground terminal of the LED backlight driving circuit, and a second end of the storage capacitor is coupled to the sixth resistor through the first controllable switch and is coupled to the output end of the fourth amplifier through the second controllable switch. The first controllable switch and the second controllable switch alternately turn on, the fourth amplifier outputs the adjusting voltage to an output end of a corresponding dimming controllable switch. When the first controllable switch turns on, the reference voltage is provided by the storage capacitor. Resistance value of the sixth resistor is equal to resistance value of the seventh resistor, and resistance value of the eighth resistor is equal to resistance value of the ninth resistor. Resistance value of the sampling resistor is 1Ω.

The present disclosure provides a specific LED backlight driving circuit. The comparing block further is configured with the second multiplier, the switching unit may calculate the conference power through switching the voltage and the current of the corresponding LED lightbar to the second multiplier. When the resistance value of the sampling resistor is equal to 1Ω, namely R=1Ω, I=V_{s1/R=V}ₛ₁, the output power of the LED lightbar is obtained through directly multiplying the adjusting voltages Vₛ₁ by the voltage of the LED lightbar, which simplifies design.

Furthermore, the switching unit comprises a fourth controllable switch and a fifth controllable switch. The output end of the first amplifier is coupled to the second multiplier through the fourth controllable switch, and an output end of the fourth amplifier is coupled to the second multiplier through the fifth controllable switch.

The decoder finds an LED lightbar having a maximum voltage, and feedbacks a voltage and current of the LED lightbar having the maximum voltage to the second multiplier of each of the comparing power blocks. The second multiplier calculates the voltage value and the current value of the LED lightbar having the maximum voltage to generate a value, which is regarded as the reference power. The voltage of the LED lightbar having the maximum voltage is equivalent to an output voltage of the first amplifier, and the current of the LED lightbar having the maximum voltage is equivalent to an output current of the fourth amplifier.

A method for driving a light emitting diode (LED) backlight driving circuit, the LED backlight driving circuit comprises a power supply, and at least two connected-in-parallel LED lightbars coupled to an output end of the power supply. The method comprising:

A: detecting an output power of each of the LED lightbars, presetting a reference power, and obtaining a difference value of the reference power compared with the output power of each of the LED lightbars.

B: adjusting the output power of each of the LED lightbars until the difference value is less than a preset threshold value.

Furthermore, the step B comprises: presetting a number increased or decreased. If the difference value is a positive value and greater than the preset threshold value, adding the number increased to the output power of the LED lightbar; determining whether the difference value between the added output power of the LED lightbar and the reference power is less than the preset threshold value. If the difference value between the added output power of the LED lightbar and the reference power is greater than or equal to the preset threshold value, continually adding the number increased to the output power of the LED lightbar until the different value is less than the preset threshold value.

If the difference value is a negative value, and an absolute value of the difference value is greater than the preset threshold value, subtracting the number decreased from the output power of the LED lightbar, and determining whether the difference value between the subtracted output power of the LED lightbar and the reference power is less than the preset threshold value. If the difference value between the subtracted output power of the LED lightbar and the reference power is greater than or equal to the preset threshold value, continually subtracting the number decreased from the output power of the LED lightbar until the different value is less than the preset threshold value.

This is a specific method for adjusting the power. The number increased or decreased is preset, after the output power of the LED lightbar is added the number increased or subtracted the number decreased every time, and the difference value is obtained through comparing the added or subtracted output power of the LED lightbar with the reference power. If the difference value still is greater than the preset threshold value, the output power of the LED lightbar is continually added the number increased or subtracted the number decreased until the difference value is less than the preset threshold value, which makes the output power of the LED lightbar is closed to the reference power, reduces brightness difference between the LED lightbars, and improves display quality.

It should be understood that each of the LED lightbars is not completely same as each other, namely, in actual use a voltage V of each of the LED lightbars is different, but a current I flowing through each of the LED lightbars is same. Thus, the output power P of each of the LED lightbars is difference, where P=V×I. Brightness of each of the LED lightbars is determined by the output power of each of the LED lightbars. When a voltage difference between the LED lightbars is great, brightness of the liquid crystal display (LCD) panel is not uneven, and this is even more true for a direct-type thin film transistor liquid crystal display (TFT-LCD) assembly, where the uneven brightness of the LCD panel is easily found because the direct-type TFT-LCD assembly does not employ a light guide plate, thus, display quality of the TFT-LCD assembly is affected. In the present disclosure, the output power of each of the LED lightbars is calculated through a detecting voltage block, a detecting current block, and the power feedback assembly, the difference value is obtained through comparing the reference power P₀ with the output power of the LED lightbar, and the output power of the corresponding LED lightbar is adjusted according to the difference value, thus the output power of each of the LED lightbars is finally closed to the reference power P₀, thereby reducing the difference of the output power between the LED lightbars, namely decreasing brightness difference between the LED lightbars and improving display quality of the TFT-LCD assembly.

### BRIEF DESCRIPTION OF FIGURES

FIG. 1 is a schematic diagram of a light emitting diode (LED) backlight driving circuit of the present disclosure.

FIG. 2 is a schematic diagram of an LED backlight driving circuit of a first example of the present disclosure.

FIG. 3 is a schematic diagram of a driving circuit of an LED lightbar of an LED backlight driving circuit of a first example of the present disclosure.

FIG. 4 is a schematic diagram of a multichannel selecting comparator of a reference power selecting block of a first example of the present disclosure.

FIG. 5 is a schematic diagram of a reference power selecting block of a first example of the present disclosure.

FIG. 6 is a schematic diagram of a comparing power block of a first example of the present disclosure.

FIG. 7 is a schematic diagram of an adjusting-power block of a first example of the present disclosure.

FIG. 8 is a schematic diagram of a converting unit of an adjusting-power block of a first example of the present disclosure.

FIG. 9 is a schematic diagram of a detecting voltage block of a first example of the present disclosure.

FIG. 10 is a schematic diagram of an LED backlight driving circuit of a second example of the present disclosure.

### DETAILED DESCRIPTION

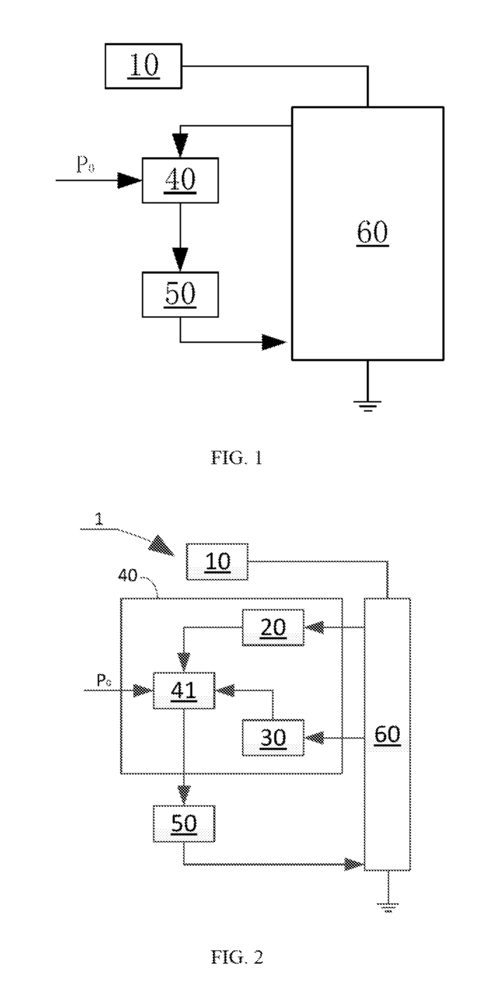

As shown in FIG. 1, the present disclosure provides a light emitting diode (LED) backlight driving circuit. The LED backlight driving circuit comprises a power supply 10, and an output end of the power supply 10 is connected to at least two connected-in-parallel LED lightbars 60. A power feedback assembly 40 and an adjusting-power block 50 coupled to the power feedback assembly 40 are coupled to each of the LED lightbars, where the power feedback assembly 40 receives an output power of the LED lightbar, and a reference power P₀ is output to a reference end of the power feedback assembly 40.

The power feedback assembly 40 compares the reference power P₀ with the output power of the LED lightbar to obtain a difference value, and the adjusting-power block 50 adjusts an output power of a corresponding LED lightbar according to the difference value until the difference value is less than a preset threshold value.

It should be understood that each of the LED lightbars is not completely same as each other, namely, in actual use a voltage V of each of the LED lightbars is different, but a current I flowing through each of the LED lightbars is same. Thus, the output power P of each of the LED lightbars is difference, where P=V×I. Brightness of each of the LED lightbars is determined by the output power P of each of the LED lightbars. When a voltage difference between the LED lightbars is great, brightness of a liquid crystal display (LCD) panel is not even, and this is even more true for a direct-type thin film transistor liquid crystal display (TFT-LCD) assembly, where the uneven brightness of the LCD panel is easily found because the direct-type TFT-LCD assembly does not employ a light guide plate, thus, display quality of the TFT-LCD assembly is affected. In the present disclosure, the output power of each of the LED lightbars is calculated through a detecting voltage block, a detecting current block, and the power feedback assembly 40, the difference value is obtained through comparing the reference power P₀ with the output power of the LED lightbar, and the output power of the corresponding LED lightbar is adjusted according to the difference value, thus the output power of each of the LED lightbars is finally closed to the reference power P₀, thereby reducing the difference of the output power between the LED lightbars, namely decreasing brightness difference between the LED lightbars and improving display quality of the TFT-LCD assembly.

The present disclosure will further be described in detail in accordance with the figures and the exemplary examples.

### EXAMPLE 1

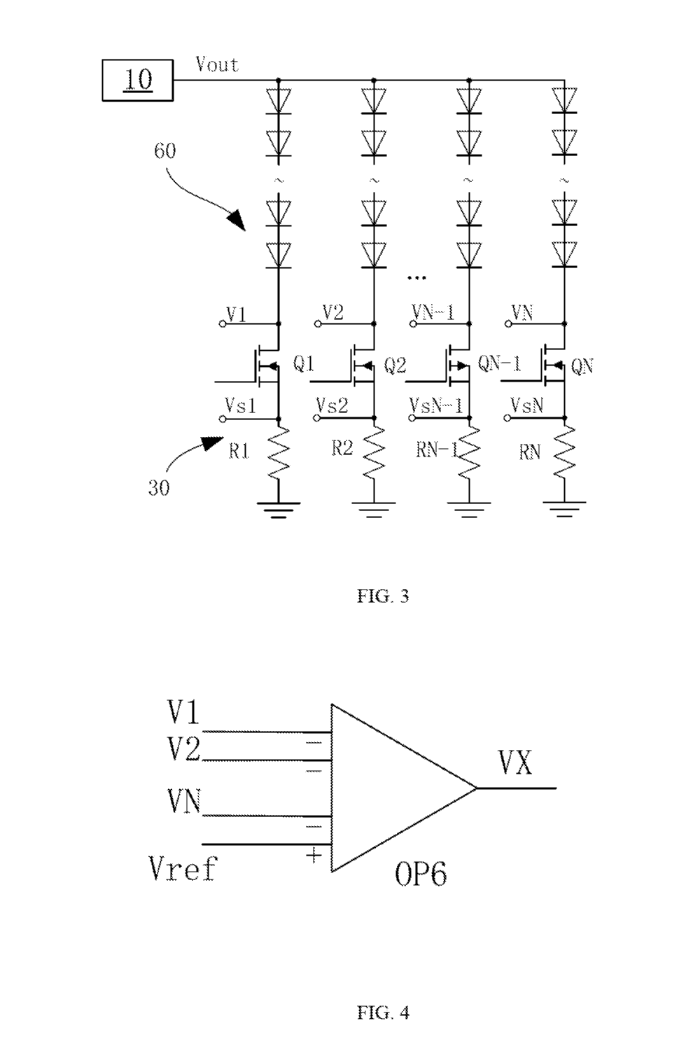

As shown in FIG. 2 to FIG. 9, the LED backlight driving circuit 1 of a first example comprises the power supply 10, and the output end of the power supply 10 is connected to at least two connected-in-parallel LED lightbars 60. The power feedback assembly 40 and the adjusting-power block 50 coupled to the power feedback assembly 40 are coupled to each of the LED lightbars 60, where the power feedback assembly 40 receives the output power of the LED lightbar, and the adjusting-power block 50 provides an adjusting voltage for the power feedback assembly 40.

The power feedback assembly 40 comprises the detecting voltage block 20 that detects the voltage of the LED lightbar, the detecting current block 30 that detects the current of the LED lightbar, and a comparing power block 41 coupled to the detecting voltage block 20 and the detecting current block 30. An output end of the comparing power block 41 is coupled to the adjusting-power block 50, and the reference power P₀ is output to a reference end of the power comparing power block 41.

The comparing power block 41 obtains the output power of the LED lightbar 60 through calculating data of the detecting voltage block 20 and the detecting current block 30, and the difference value V_{z1} is obtained through comparing the reference power P₀ with the output power of the LED lightbar. The adjusting-power block 50 adjusts the output power of the corresponding LED lightbar according to the difference value V_{z1} until the difference value V_{z1} is less than the preset threshold value. Ideally, the preset threshold value is zero. However, in actual use, the preset threshold value is as small as possible when technology and cost are satisfied.

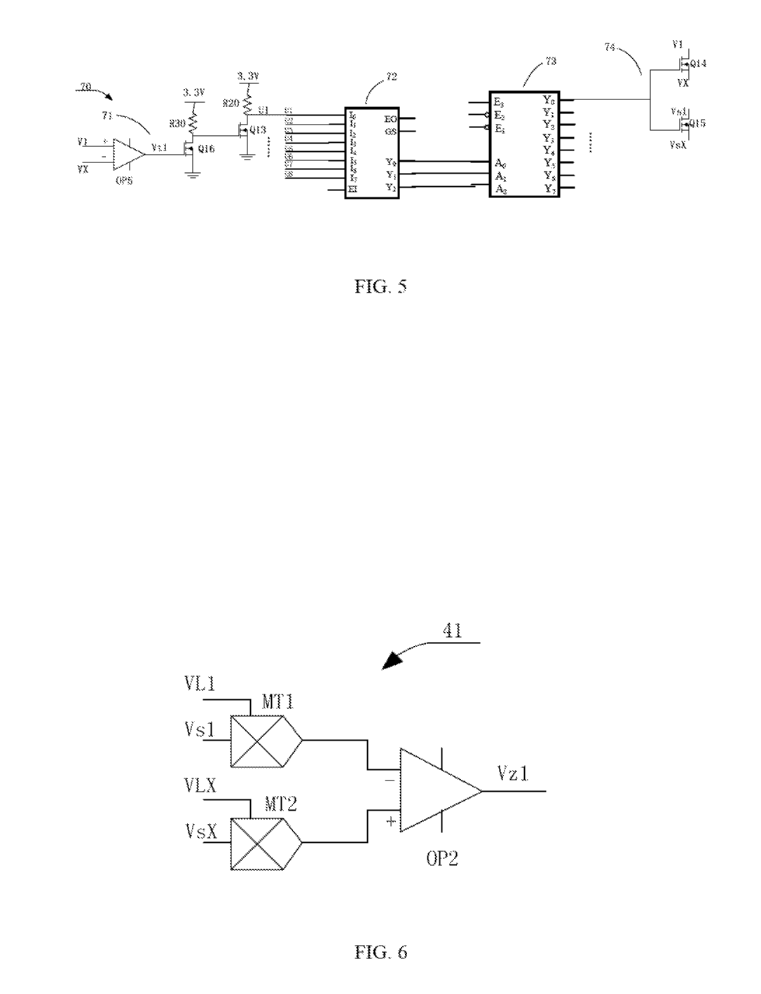

As shown in FIG. 4 and FIG. 5, the LED backlight driving circuit further comprises a reference power selecting block 70. The reference power selecting block 70 comprises a comparing unit 71, an encoder 72, a decoder 73, a switching unit 74, and a multichannel selecting comparator OP6 coupled to a cathode end of each of the LED lightbars 60. The multichannel selecting comparator OP6 is used to select a minimum voltage of the cathode end of the LED lightbar 60 in all voltages of the cathode ends of the LED lightbars 60. Each of the LED lightbars 60 corresponds to one comparing unit 71. The comparing unit 71 comprises a comparator OP5 and a third controllable switch Q13. A non-inverting end of the comparator OP5 is coupled to an output end of the multichannel selecting comparator OP6, an inverting input end of the comparator OP5 is coupled to the cathode end of the corresponding LED lightbar 60, and an output end of the comparator OP5 is coupled to a control end of a sixth controllable switch Q16, where the non-inverting end of the comparator OP5 is a first input end of the comparator OP5, the inverting input end of the comparator OP5 is a second input end of the comparator OP5. An input end of the sixth controllable switch Q16 is coupled to a control end of the third controllable switch Q13, and receives a reference high level signal (such as 3.3V, 5V) through a first divider resistor R30. An input end of the third controllable switch Q13 is coupled to the encoder 72 and receives the reference high level signal (such as 3.3V, 5V) through a second divider resistor R20, and an output end of the third controllable switch Q13 is connected with a ground terminal of the LED backlight driving circuit. An output signal of the comparator OP5 is transformed into a transistor-transistor logic (TTL) signal through the third controllable switch Q13 and the second divider resistor R20, and the TTL signal can be detected by the encoder 72.

The encoder 72 reads an output value of each of the comparing units 71. The decoder 73 finds the LED lightbar 60 having the minimum voltage in the cathode end of the LED lightbar according to the data of the encoder 72, and controls the switching unit 74 to switch the output power of the LED lightbar 60 having the minimum voltage in the cathode end of the LED lightbar to the reference end of the comparing power block 41 corresponding to each of the LED lightbars 60, where the output power of the LED lightbar 60 having the minimum voltage in the cathode end of the LED lightbar is regarded as the reference power.

In the first example, the output power of the LED lightbar 60 having a maximum voltage is regarded as the reference power. When the LED backlight driving circuit works, the power supply firstly uses a constant current to drive, and the multichannel selecting comparator OP6 selects the minimum voltage of the cathode end of the LED lightbar 60. When the voltage of the cathode end of the LED lightbar 60 is at a minimum, the voltage of the LED lightbar 60 is at a maximum. The comparing unit 71 compares a minimum voltage output by the multichannel selecting comparator OP6 with the voltage of the cathode end of each of the LED lightbars 60, and outputs digital signals (Vt1-VtN). As the voltage of the cathode end of only one LED lightbar is equal to the minimum voltage output by the multichannel selecting comparator OP6, the digital signal output by the comparing unit 71 corresponding to the one LED lightbar is different from the digital signals outputted by other comparing units 71 corresponding remaining LED lightbars (namely, if the comparing unit corresponding to the one LED lightbar outputs logic 0, the other comparing units output logic 1. On the contrary, if the comparing unit corresponding to the one LED lightbar outputs logic 1, the other comparing units output logic 0). The comparing unit 71 transfers the digital signal to the encoder 72, where the digital signal is obtained according to a compared result. The decoder 73 finds the LED lightbar 60 having the minimum voltage in the cathode end of the LED lightbar, and controls the switching unit 74 to switch the output power of the LED lightbar 60 having the minimum voltage in the cathode end of the LED lightbar to the reference end of the comparing power block 41 corresponding to each of the LED lightbars, where the output power of the LED lightbar 60 having the minimum voltage in the cathode end of the LED lightbar is regarded as the reference power. Truth tables of the decoder 73 and the encoder 72 are shown in table 1, where H is logic 1, and L is logic 0.

TABLE 1

| Input | | | | | | | | | Output | | | | |
|---|---|---|---|---|---|---|---|---|---|---|---|---|---|
| EI | I₇ | I₆ | I₅ | I₄ | I₃ | I₂ | I₁ | I₀ | Y₂ | Y₁ | Y₀ | GS | EO |
| L | x | x | x | x | x | x | x | x | L | L | L | L | L |
| H | H | H | H | H | H | H | H | H | L | L | L | L | H |
| H | L | x | x | x | x | x | x | x | H | H | H | H | L |
| H | H | L | x | x | x | x | x | x | H | H | L | H | L |
| H | H | H | L | x | x | x | x | x | H | L | H | H | L |
| H | H | H | H | L | x | x | x | x | H | L | L | H | L |
| H | H | H | H | H | L | x | x | x | L | H | H | H | L |
| H | H | H | H | H | H | L | x | x | L | H | L | H | L |
| H | H | H | H | H | H | H | L | x | L | L | H | H | L |
| H | H | H | H | H | H | H | H | L | L | L | L | H | L |

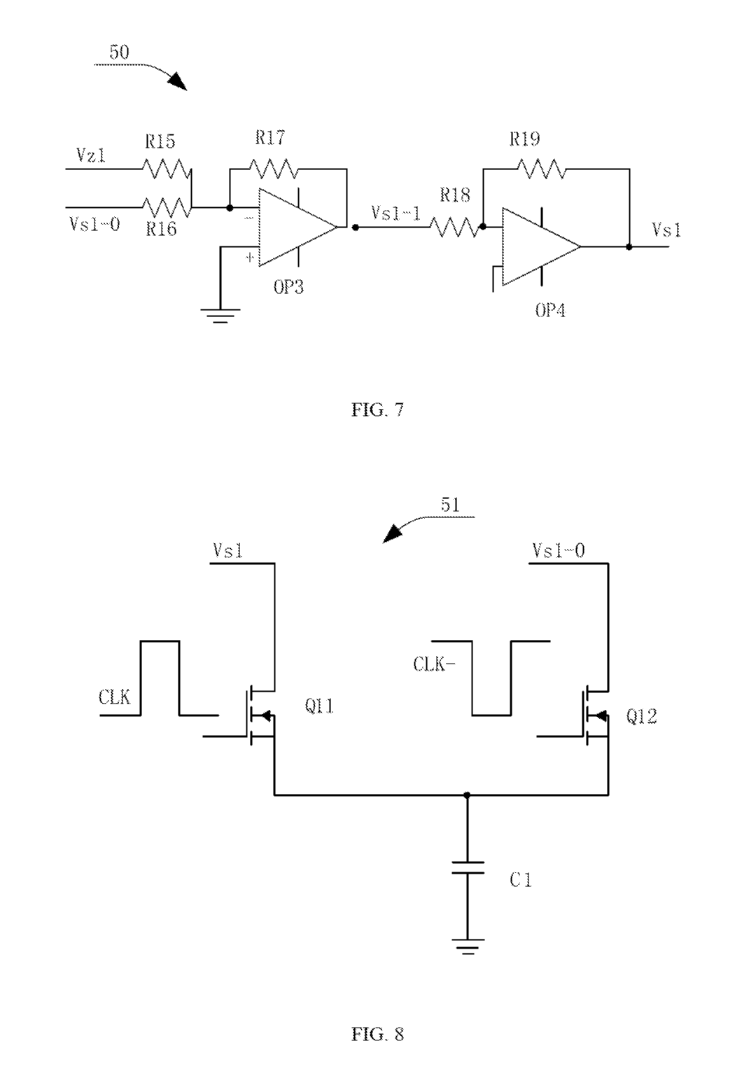

As shown in FIG. 5 and FIG. 6, the comparing power block 41 comprises a first multiplier MT1, a second multiplier MT2, and a second amplifier OP2. The first multiplier MT1 receives the adjusting voltage of the adjusting-power block 50 and is coupled to an output end of a first amplifier OP1, and an output end of the first multiplier MT1 is coupled to an inverting end of the second amplifier OP2, where the inverting end of the second amplifier OP2 is a second input end of the second amplifier OP2.

The switching unit 74 comprises a fourth controllable switch Q14 and a fifth controllable switch Q15. The output end of the first amplifier OP1 is coupled to the second multiplier MT2 through the fourth controllable switch Q14, and an output end of the fourth amplifier OP4 is coupled to the second multiplier MT2 through the fifth controllable switch Q15. The second multiplier MT2 outputs the reference power to a non-inverting end of the second amplifier OP2, and an output end of the second amplifier OP2 is coupled to the adjusting-power block 50.

The decoder 73 finds the LED lightbar having the maximum voltage, and feedbacks the voltage and the current of the LED lightbar having the maximum voltage to the second multiplier MT2 of each of the comparing power blocks 41. The second multiplier MT2 calculates the voltage value and the current value of the LED lightbar having the maximum voltage to generate a value, which is regarded as the reference power. The voltage of the LED lightbar having the maximum voltage is equivalent to an output voltage of the first amplifier OP1, and the current of the LED lightbar having the maximum voltage is equivalent to an output current of the fourth amplifier OP4.

As shown in FIG. 7 and FIG. 8, the adjusting-power block 50 comprises a third amplifier OP3, the fourth amplifier OP4, a fifth resistor R15, a sixth resistor R16, a seventh resistor R17, an eighth resistor R18, and a ninth resistor R19. An inverting end of the third amplifier OP3 is coupled to the output end of the comparing power block 41 through the fifth resistor R15, receives a reference voltage Vs1-0 through the sixth resistor R16, and is coupled to an output end of the third amplifier OP3 through the seventh resistor R17, where the inverting end of the third amplifier is a second input end of the third amplifier. The output end of the third amplifier OP3 is coupled to a first input end of the fourth amplifier OP4 through the eighth resistor R18, and the first input end of the fourth amplifier OP4 is coupled to an output end of the fourth amplifier OP4 through the ninth resistor R19. A second input end of the fourth amplifier OP4 is coupled to the ground terminal of the LED backlight driving circuit.

The adjusting-power block 50 further comprises a converting unit 51. The converting unit 51 comprises a first controllable switch Q11, a second controllable switch Q12, and a storage capacitor C1. A first end of the storage capacitor C1 is coupled to the ground terminal of the LED backlight driving circuit, and a second end of the storage capacitor C1 is coupled to the sixth resistor R16 through the first controllable switch Q11 and is coupled to the output end of the fourth amplifier OP4 through the second controllable switch Q12. The first controllable switch Q11 and the second controllable switch Q12 alternately turn on. A control signal CLK of the first controllable switch Q11 and a control signal CLK—of the second controllable switch Q12 can be provided by a time sequence driving circuit of the LCD panel. The fourth amplifier OP4 outputs the adjusting voltage to an output end of a corresponding dimming controllable switch. When the first controllable switch Q11 turns on, the reference voltage is provided by the storage capacitor C1.

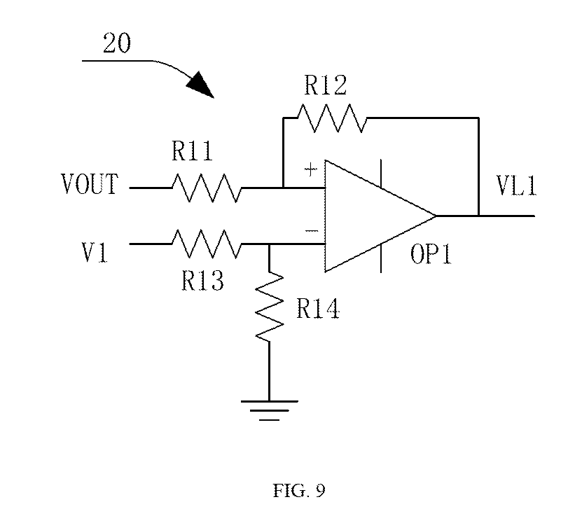

As shown in FIG. 9, the detecting voltage block 20 comprises the first amplifier OP1, a first resistor R11, a second resistor R12, a third resistor R3, and a fourth resistor R14. A non-inverting end of the first amplifier OP1 receives the output voltage of the power supply through the first resistor R11 and is coupled to an output end of the first amplifier OP1 through the third resistor R13, and an inverting end of the first amplifier OP1 receives the voltage of the cathode end of the LED lightbar through the second resistor R12 and is coupled to the ground terminal of the LED backlight driving circuit through the fourth resistor R14, where the non-inverting end of the first amplifier OP1 is a first input end of the amplifier OP1, and the inverting end of the first amplifier OP1 is a second input end of the amplifier OP1.

The cathode end of the LED light bar is connected with the dimming controllable switch in series. The detecting current block 30 comprises a sampling resistor connected in series between the dimming controllable switch and the ground terminal of the LED backlight driving circuit. The adjusting-power block 50 provides the adjusting voltage to the output end of the dimming controllable switch.

The first example provides a specific LED backlight driving circuit. The power feedback assembly 40 obtains the output power of each of the LED lightbars through the first multiplier MT1. The switching unit 74 switches the current and the voltage of the LED lightbar having the minimum voltage in the cathode end of the LED lightbar to the second multiplier MT2, and the reference power is calculated through the second multiplier MT2. The output power of each of the LED lightbars is compared with the reference power through the second amplifier OP12 to obtain the difference value of the power.

The detecting voltage block 20 obtains the voltage of each of the LED lightbars through subtracting the voltage of the cathode end of the LED lightbar from a voltage of an anode end of the LED lightbars. It should be considered that resistance of the LED lightbar can be pre-measured, and the current of the LED lightbar is detected, according to Ohm's law, the voltage of the LED lightbar can be calculated.

The first example obtains the current of the LED lightbar through the adjusting voltage, and adjusts the current of the LED lightbar through adjusting the adjusting-power block 50. If the adjusting voltage is regarded as Vₛ₁ (taking a first LED lightbar for example as follows), the resistance value of the sampling resistor is R, according to Ohm's law, a current flowing through the sampling resistor is I, where I=Vₛ₁/R. The first LED lightbar is connected in series with the sampling resistor, thus, the current of the sampling resistor is equal to the current of the LED lightbar. When R=1, Ω, I=Vₛ₁, therefore, the output power of the first LED lightbar is obtained through directly multiplying the adjusting voltages Vₛ₁ by the voltage of the first LED lightbar, which simplifies design. When R≠1Ω, the current I of the sampling resistor and the adjusting voltage Vₛ₁ are directly proportional, thus, the adjusting voltage Vₛ₁ reflects change of the current of the sampling resistor. It should be considered that the current of the LED lightbar is directly obtained through a converter or a current sensor.

Resistance value of the fifth resistor, resistance value of the sixth resistor, resistance value of the seventh resistor, resistance value of the eighth resistor, resistance value of the ninth resistor, the reference voltage, and the difference value output by the power feedback assembly 40 are respectively regarded as R15, R16, R17, R18, R19, Vₛ₁₋₀, and V_{z1}. The output voltage of the fourth amplifier OP4 is Vₛ₁, where Vₛ₁=Vₛ₁₋₀R17/R16±V_{z1}×R17/R15. The converting unit 51 switches the output voltage Vₛ₁ of the fourth amplifier OP4 to a first input end of the sixth resistor, where the output voltage Vₛ₁ of the fourth amplifier OP4 is regarded as a new reference voltage. Thus, the converting unit 51 switches every time, the output voltage Vₛ₁ of the fourth amplifier OP4 increases or decreases a number (the number increased or decreased is V_{z1}×R17/R15). Change of the output voltage Vₛ₁ of the fourth amplifier directly affects the output power of the corresponding LED lightbar, thus, the present disclosure can gradually adjust change of the output power of the LED lightbar until the difference value is less than the preset threshold value. At this time, V_{z1}=0, namely the number increased or decreased is zero, and the output voltage Vₛ₁ of the fourth amplifier does not change.

Resistance values and value relationship of the fifth resistor, the sixth resistor, and the seventh resistor are strictly limited. In the example, the resistance value of the sixth resistor is equal to the resistance value of the seventh resistor, the resistance value of the fifth resistor is less than the resistance value of the seventh resistor, and the resistance value of the eighth resistor is equal to the resistance value of the ninth resistor. As R15<R17, R17/R15>1. Generally, V_{z1} is small, thus, in the formula of Vₛ₁=Vₛ₁₋₀R17/R16±V_{z1}×R17/R15, V_{z1}×R17/R15 of the number increased or decreased is dependent on R17/R15. When the number increased or decreased becomes greater, the speed of reducing the different value between the output power of the LED lightbar and the reference power by the adjusting-power block 50 becomes faster, which improves feedback efficiency.

In the present disclosure, the first controllable switch, the second controllable switch, the third controllable switch, the fourth controllable switch, and the fifth controllable switch may use a controllable semiconductor device, such as a metal-oxide-semiconductor field-effect transistor (MOSFET). The circuits connected with the first input end and the second input end of each of the comparators can be interchanged, and the circuits connected with the first input end and the second input end of each of the amplifiers can be interchanged, at this time, logical operation of the comparators or the amplifiers is opposite accordingly.

### EXAMPLE 2

The present disclosure provides a method for driving the LED backlight driving circuit, the LED backlight driving circuit comprises the power supply 10, and at least two connected-in-parallel LED lightbars 60 are connected to the output end of the power supply 10. The method comprises:

A: detecting the output power of each of the LED lightbars, presetting the reference power, and obtaining the difference value of the reference power compared with the output power of each of the LED lightbars; and

B: adjusting the output power of each of the LED lightbars until the difference value is less than the preset threshold value.

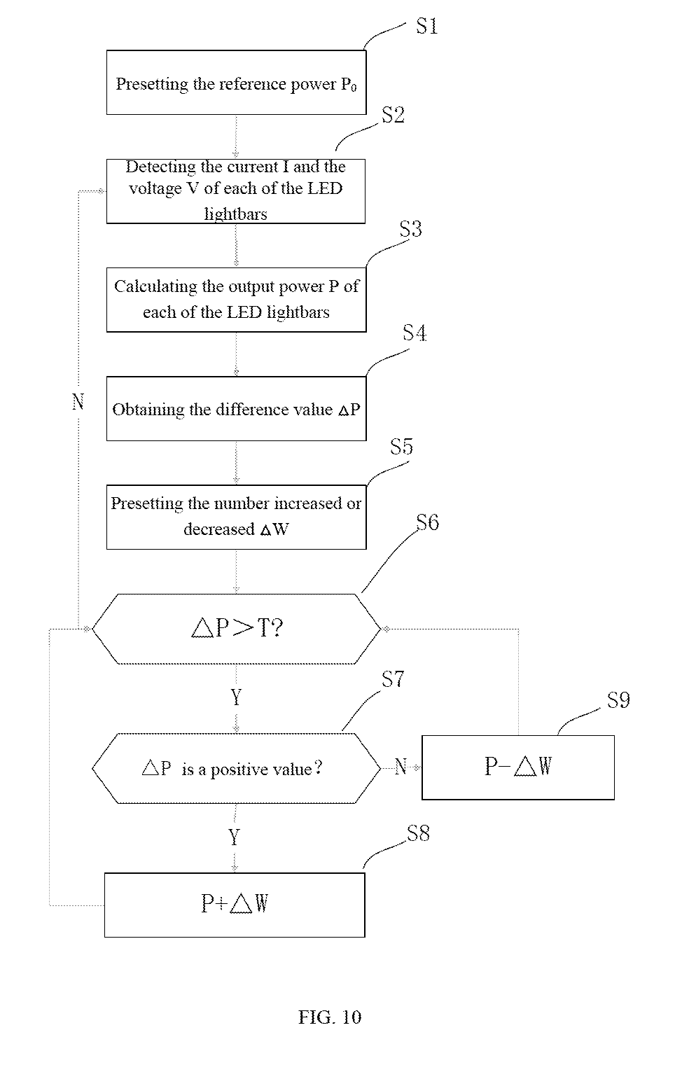

To be specific, as shown in FIG. 10:

The step A comprises:
S1: presetting the reference power P₀;
S2: detecting the current I and the voltage V of each of the LED lightbars;
S3: calculating the output power P of each of the LED lightbars according to the current I and the voltage V of each of the LED lightbars; and
S4: obtaining the difference value ΔP of the output power P of each of the LED lightbars compared with the reference power P₀.

The step B comprises:
S5: presetting the number increased or decreased ΔW (the step S5 also can be finished in the step S1);
S6: determining whether an absolute value of the difference value ΔP is greater than the preset threshold value, if the absolute value of the difference value ΔP is greater than the preset threshold value, doing the step S7. If the absolute value of the difference value ΔP is less than and equal to the preset threshold value, returning to do the step S6;
S7: if the difference value ΔP is a positive value, doing the step S8. If the difference value ΔP is a negative value, doing the step S9;
S8: adding the number increased ΔW to the output power of the LED lightbar, and determining whether the difference value ΔP between the added output power P of the LED lightbar and the reference power P₀ is less than the preset threshold value, if the difference value ΔP between the added output power of the LED lightbar and the reference power P₀ is greater than or equal to the preset threshold value, continually adding the number increased ΔW to the output power of the LED lightbar until the different value ΔP between the added output power of the LED lightbar and the reference power P₀ is less than the preset threshold value, and returning to do the step S6; and
S9: subtracting the number decreased ΔW from the output power of the LED lightbar, and determining whether the difference value ΔP between the subtracted output power of the LED lightbar and the reference power P₀ is less than the preset threshold value, if the difference value ΔP between the subtracted output power P of the LED lightbar and the reference power P₀ is greater than or equal to the preset threshold value, continually subtracting the number decreased ΔW from the output power of the LED lightbar until the different value ΔP between the subtracted output power P of the LED lightbar and the reference power P₀ is less than the preset threshold value, and returning to do the step S6.

The preset disclosure is described in detail in accordance with the above contents with the specific exemplary examples. However, this present disclosure is not limited to the specific examples. For the ordinary technical personnel of the technical field of the preset disclosure, on the premise of keeping the conception of the present disclosure, the technical personnel can also make simple deductions or replacements, and all of which should be considered to belong to the protection scope of the present disclosure.

We claim:

1. A light emitting diode (LED) backlight driving circuit, comprising:
a power supply:
at least two connected-in-parallel LED lightbars connected to an output end of the power supply;
a power feedback assembly coupled to each of the LED lightbars; and
an adjusting-power block coupled to the power feedback assembly;
wherein a reference end of the power feedback assembly receives a reference power, and the power feedback assembly receives an output power of each of the LED lightbars;
wherein the power feedback assembly obtains a difference value of the reference power compared with the output power of the LED lightbar, and the adjusting-power block adjusts the output power of a corresponding LED lightbar according to the difference value until the difference value is less than a preset threshold value.

2. The LED backlight driving circuit of claim 1, wherein the adjusting-power block comprises a third amplifier, a fourth amplifier, a fifth resistor, a sixth resistor, a seventh resistor, an eighth resistor, and a ninth resistor; a second input end of the third amplifier is coupled to an output end of the power feedback assembly through the fifth resistor, receives a reference voltage through the sixth resistor, and is coupled to an output end of the third amplifier through the seventh resistor; the output end of the third amplifier is coupled to a first input end of the fourth amplifier through the eighth resistor, and the first input end of the fourth amplifier is coupled to an output end of the fourth amplifier through the ninth resistor; a second input end of the fourth amplifier is coupled to a ground terminal of the LED backlight driving circuit;
wherein the adjusting-power block further comprises a converting unit; the converting unit comprises a first controllable switch, a second controllable switch, and a storage capacitor; a first end of the storage capacitor is coupled to the ground terminal of the LED backlight driving circuit, and a second end of the storage capacitor is coupled to the sixth resistor through the second controllable switch and is coupled to the output end of the fourth amplifier through the first controllable switch; the first controllable switch and the second controllable switch alternately turn on; when the first controllable switch turns on, the reference voltage is provided by the storage capacitor.

3. The LED backlight driving circuit of claim 2, wherein resistance value of the sixth resistor is equal to resistance value of the seventh resistor, resistance value of the fifth resistor is less than resistance value of the seventh resistor.

4. The LED backlight driving circuit of claim 1, further comprising a reference power selecting block; the reference power selecting block comprises a multichannel selecting comparator coupled to a cathode end of each of the LED lightbars; the multichannel selecting comparator is used to select a minimum voltage of the cathode end of the LED lightbar in all voltages of the cathode ends of the LED lightbars; each of the LED lightbars corresponds to one comparing unit; a first input end of the comparing unit is coupled to an output end of the multichannel selecting comparator, and a second input end of the comparing unit is coupled to the cathode end of the corresponding LED lightbar;
wherein the reference power selecting block further comprises an encoder, a decoder, a switching unit; the encoder reads an output value of each of the comparing unit; the decoder finds the LED lightbar having the minimum voltage in the cathode end of the LED lightbar and controls the switching unit to switch the output power of the LED lightbar having the minimum voltage in the cathode end of the LED lightbar to a reference end of a corresponding power feedback assembly; the output power of the corresponding LED lightbar is regarded as the reference power.

5. The LED backlight driving circuit of claim 1, wherein the power feedback assembly comprises a detecting voltage block that detects a voltage of the LED lightbar, a detecting current block that detects current of the LED lightbar, and a comparing power block coupled to the detecting voltage block and the detecting current block; the comparing power block is coupled to the adjusting-power block;
wherein the detecting voltage block comprises a first amplifier, a first resistor, a second resistor, a third resistor, and a fourth resistor; a first input end of the first amplifier receives an output voltage of the power supply through the first resistor and is coupled to an output end of the first amplifier through the second resistor, and a second input end of the first amplifier receives the voltage of the cathode end of the LED lightbar through the third resistor and is coupled to a ground terminal of the LED backlight driving circuit through the fourth resistor; the output end of the first amplifier is coupled to the power feedback assembly.

6. The LED backlight driving circuit of claim 5, wherein the comparing power block comprises a first multiplier and a second amplifier; output ends of the detecting voltage block and the detecting current block are coupled to the first multiplier; an output end of the first multiplier is coupled to a second input end of the second amplifier; a first input end of the second amplifier receives the reference power, an output end of the second amplifier is coupled to the adjusting-power block.

7. The LED backlight driving circuit of claim 1, wherein the power feedback assembly comprises a detecting voltage block that detects a voltage of the LED lightbar, a detecting current block that detects current of the LED lightbar, and a comparing power block coupled to the detecting voltage block and the detecting current block; the comparing power block is coupled to the adjusting-power block, and a reference end of the comparing power block receives the reference power; the detecting current block comprises a sampling resistor connected in series between a cathode end of the LED lightbar and a ground terminal of the LED backlight driving circuit; the adjusting-power block provides an adjusting voltage to the cathode end of the LED lightbar; the power feedback assembly receives the adjusting voltage.

8. The LED backlight driving circuit of claim 7, wherein the comparing power block comprises a first multiplier and a second amplifier; output ends of the detecting voltage block and the detecting current block are coupled to the first multiplier; an output end of the first multiplier is coupled to a second input end of the second amplifier; a first input end of the second amplifier receives the reference power, an output end of the second amplifier is coupled to the adjusting-power block.

9. The LED backlight driving circuit of claim 1, further comprising a reference power selecting block; the reference power selecting block comprises a multichannel selecting comparator coupled to the cathode end of each of the LED lightbars; the multichannel selecting comparator is used to select a minimum voltage of the cathode end of the LED lightbar in all voltages of the cathode ends of the LED lightbars; each of the LED lightbars corresponds to one comparing unit; a first input end of the comparing unit is coupled to an output end of the multichannel selecting comparator, and a second input end of the comparing unit is coupled to the cathode end of the corresponding LED lightbar;
wherein the power feedback assembly comprises a detecting voltage block that detects a voltage of the LED lightbar, a detecting current block that detects current of the LED lightbar, and a comparing power block coupled to the detecting voltage block and the detecting current block; the comparing power block is coupled to the adjusting-power block;
wherein the reference power selecting block further comprises an encoder, a decoder, a switching unit; the encoder reads an output value of each of the comparing unit; the decoder finds the LED lightbar having the minimum voltage in the cathode end of the LED lightbar and controls the switching unit to switch the output power of the LED lightbar having the minimum voltage in the cathode end of the LED lightbar to a reference end of a corresponding comparing power block; the output power of the corresponding LED lightbar is regarded as the reference power;
wherein the detecting voltage block comprises a first amplifier, a first resistor, a second resistor, a third resistor, and a fourth resistor; a first input end of the first amplifier receives an output voltage of the power supply through the first resistor and is coupled to an output end of the first amplifier through the second resistor, and a second input end of the first amplifier receives the voltage of the cathode end of the LED lightbar through the third resistor and is coupled to a ground terminal of the LED backlight driving circuit through the fourth resistor;
wherein the cathode end of the LED light bar is connected with a dimming controllable switch in series; the detecting current block comprises a sampling resistor connected in series between the dimming controllable switch and the ground terminal of the LED backlight driving circuit; the adjusting-power block provides an adjusting voltage to an output end of the dimming controllable switch;
wherein the comparing power block comprises a first multiplier, a second multiplier, and a second amplifier; the first multiplier receives the adjusting voltage of the adjusting-power block and is coupled to the output end of the first amplifier, and an output end of the first multiplier is coupled to a second input end of the second amplifier; the switching unit of the reference power selecting block switches the output end of the first amplifier corresponding to the LED lightbar having the minimum voltage in the cathode end of the LED lightbar and the adjusting voltage to the second multiplier; the second multiplier outputs the reference power to a first input end of the second amplifier; an output end of the second amplifier is coupled to the adjusting-power block;
wherein the adjusting-power block comprises a third amplifier, a fourth amplifier, a fifth resistor, a sixth resistor, a seventh resistor, an eighth resistor, and a ninth resistor; a second input end of the third amplifier is coupled to an output end of the comparing power block through the fifth resistor, receives a reference voltage through the sixth resistor, and is coupled to an output end of the third amplifier through the seventh resistor; the output end of the third amplifier is coupled to a first input end of the fourth amplifier through the eighth resistor, and the first input end of the fourth amplifier is coupled to an output end of the fourth amplifier through the ninth resistor; a second input end of the fourth amplifier is coupled to the ground terminal of the LED backlight driving circuit;
wherein the adjusting-power block further comprises a converting unit; the converting unit comprises a first controllable switch, a second controllable switch, and a storage capacitor; a first end of the storage capacitor is coupled to the ground terminal of the LED backlight driving circuit, and a second end of the storage capacitor is coupled to the sixth resistor through the second controllable switch and is coupled to the output end of the fourth amplifier through the first controllable switch; the first controllable switch and the second controllable switch alternately turn on;
the fourth amplifier outputs the adjusting voltage to an output end of a corresponding dimming controllable switch; when the first controllable switch turns on, the reference voltage is provided by the storage capacitor; resistance value of the sixth resistor is equal to resistance value of the seventh resistor, and resistance value of the eighth resistor is equal to resistance value of the ninth resistor; resistance value of the sampling resistor is 1Ω.

10. A method for driving a light emitting diode (LED) backlight driving circuit, the LED backlight driving circuit comprising a power supply and at least two connected-in-parallel LED light bars coupled to an output end of the power supply; the method comprising:
A: detecting an output power of each of the LED lightbars, presetting a reference power, and obtaining a difference value of the reference power compared with the output power of each of the LED lightbars; and
B: adjusting the output power of each of the LED lightbars until the difference value is less than a preset threshold value.

11. The method for driving the LED backlight driving circuit of claim 10, wherein the step B comprises:
presetting a number increased or decreased; if the difference value is a positive value and greater than the preset threshold value, adding the number increased to the output power of the LED lightbar, and determining whether the difference value between the added output power of the LED lightbar and the reference power is less than the preset threshold value; if the difference value between the added output power of the LED lightbar and the reference power is greater than or equal to the preset threshold value, continually adding the number increased to the output power of the LED lightbar until the different value is less than the preset threshold value;
if the difference value is a negative value, and an absolute value of the difference value is greater than the preset threshold value, subtracting the number decreased from the output power of the LED lightbar, and determining whether the difference value between the subtracted output power of the LED lightbar and the reference power is less than the preset threshold value; if the difference value between the subtracted output power of the LED lightbar and the reference power is greater than or equal to the preset threshold value, continually subtracting the number decreased from the output power of the LED lightbar until the different value is less than the preset threshold value.
